(19) United States
(12) Patent Application Publication
(10) Pub. No.: US 2021/0363028 A1
(43) Pub. Date: Nov. 25, 2021

(54) MODULAR PRESSURIZED WATER FILTRATION SYSTEM

(71) Applicant: Phoenix Revolution, Inc., Quincy, MA (US)

(72) Inventors: Casey GLYNN, Somerville, MA (US); Shawn HUDON, Canton, MA (US); Chad GROVER, Columbia, CT (US); Forrest GROVER, Columbia, CT (US)

(21) Appl. No.: 16/882,383

(22) Filed: May 22, 2020

(51) Int. Cl. C02F 1/00; C02F 1/44; B01D 61/02; B01D 61/08; B01D 61/12; B01D 65/02

(52) U.S. Cl. CPC C02F 1/008; B01D 2321/16; B01D 61/025; B01D 61/08; B01D 61/12; B01D 65/022; C02F 2209/03; C02F 2303/16; C02F 2209/40; C02F 2201/005; B01D 2311/14; B01D 2313/18; B01D 2313/243; B01D 2313/246; B01D 2317/04; C02F 1/441

(57) ABSTRACT

Numerous water filtration systems are disclosed. Each filtration system contains one or more filtration units, and each filtration unit contains one or more membrane units. Each membrane unit receives impure water at high-pressure and filters the water with one or more reverse-osmosis membranes, yielding clean water. Leftover brine is discarded or mixed back into the input with the impure water. Each filtration system further comprises a control unit for controlling a feed valve, brine valve, and product valve for each membrane unit. Optionally, the control unit can sequence those activities to achieve constant energy consumption, minimal energy consumption, or constant output of clean water.

### FIELD OF THE INVENTION

Numerous water filtration systems are disclosed. Each filtration system contains one or more filtration units, and each filtration unit contains one or more membrane units. Each membrane unit receives impure water at high-pressure and filters the water with one or more reverse-osmosis membranes, yielding clean water. Leftover brine is discarded or mixed back into the input with the impure water. Each filtration system further comprises a control unit for controlling a feed valve, brine valve, and product valve for each membrane unit. Optionally, the control unit can sequence those activities to achieve constant energy consumption, minimal energy consumption, or constant output of clean water.

### BACKGROUND OF THE INVENTION

Clean water is becoming increasingly scarce in many parts of the world. This will worsen with global warming and continued environmental pollution.

The prior art includes numerous water filtration systems that can be used to filter impure water to yield clean water. FIG. 1 depicts an example of prior art filtration system 100. Filtration system 100 receives impure water feed 101, which contains water that is not suitable for the desired purpose. For example, impure water feed 101 might comprise contaminated water from a lake or river, ocean water, or heavy mineralized water that is a byproduct of a fracking process. Filtration system 100 filters impure water feed 101 to generate clean water product 102 and brine 103. Brine 103 is a wastewater that is even more contaminated or impure than impure water feed 101. Typically, brine 103 is discarded in a landfill or similar location, optionally after a portion of the liquid evaporates. Clean water product 102 can then be used for consumption by humans or animals, for irrigation, or in the case of fracking, can be clean enough to be deposited into a body of water such as a river or ocean.

Prior art filtration systems such as filtration system 100 suffer from numerous drawbacks. Prior art systems do not yield enough clean water for the amount of power consumed. Many prior art systems cannot scale upward to meet demand as demand increases. Prior art systems require significant downtime for its components to be cleaned or replaced.

What is needed is an improved filtration system that has a higher yield of clean water per watt of power consumed, that can scale upward to meet demand as demand increases, and whose components can be cleaned or replaced without taking the system offline.

### SUMMARY OF THE INVENTION

Numerous water filtration systems are disclosed. Each filtration system contains one or more filtration units, and each filtration unit contains one or more membrane units. Each membrane unit receives impure water at high-pressure and filters the water with one or more reverse-osmosis membranes, yielding clean water. Leftover brine is discarded or mixed back into the input with the impure water. Each filtration system further comprises a control unit for controlling a feed valve, brine valve, and product valve for each membrane unit. Optionally, the control unit can perform such synchronization to achieve constant energy consumption, minimal energy consumption, or constant output of clean water.

### BRIEF DESCRIPTION OF THE DRAWINGS

FIG. 1 depicts a prior art filtration system.

FIG. 2 depicts a membrane unit.

FIG. 3A depicts a pressurizing stage for the membrane unit.

FIG. 3B depicts a depressurizing stage for the membrane unit.

FIG. 3C depicts a purging stage for the membrane unit.

FIG. 4 depicts a filtration unit comprising a plurality of membrane units.

FIG. 5 depicts another filtration unit comprising a plurality of membrane units.

FIG. 6A depicts a cleaning injection stage for the membrane unit.

FIG. 6B depicts a cleaning discharge stage for the membrane unit.

FIG. 7 depicts a water transportation stage for the membrane unit.

FIG. 8 depicts a plurality of membrane units in various stages.

FIG. 9 depicts a filtration unit comprising a plurality of membrane units and an opening near each membrane unit.

FIG. 10 depicts a pre-filter unit.

FIG. 11 depicts a filtration unit comprising a plurality of membrane units and an energy recovery device.

FIG. 12 depicts a filtration system comprising a plurality of filtration units.

FIG. 13 depicts three modes implemented by a control unit in a filtration system.

FIG. 14 contains pressure characteristic graphs for the three modes of FIG. 13.

FIG. 15 depicts a control system used in a filtration system.

FIG. 16 depicts a cloud system for controlling and interacting with the control unit of FIG. 15.

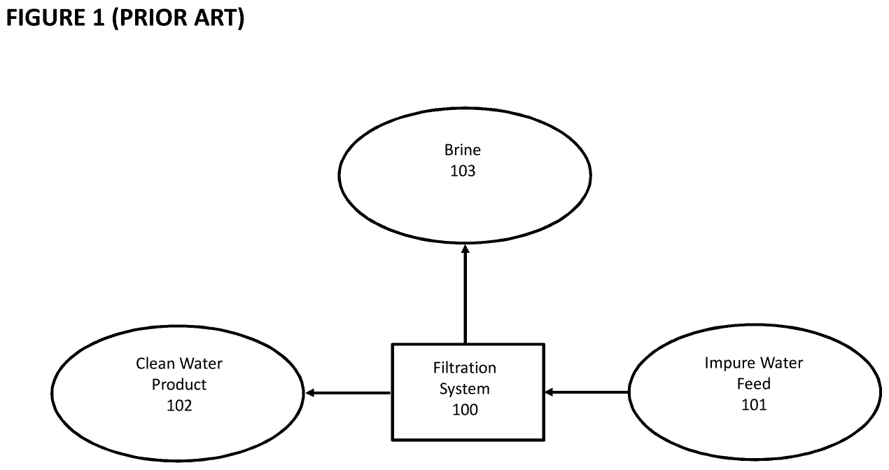

### DETAILED DESCRIPTION OF THE INVENTION

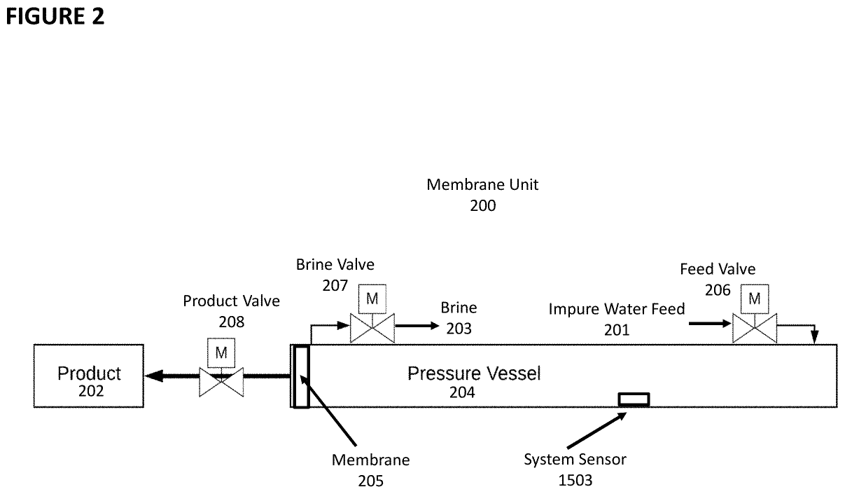

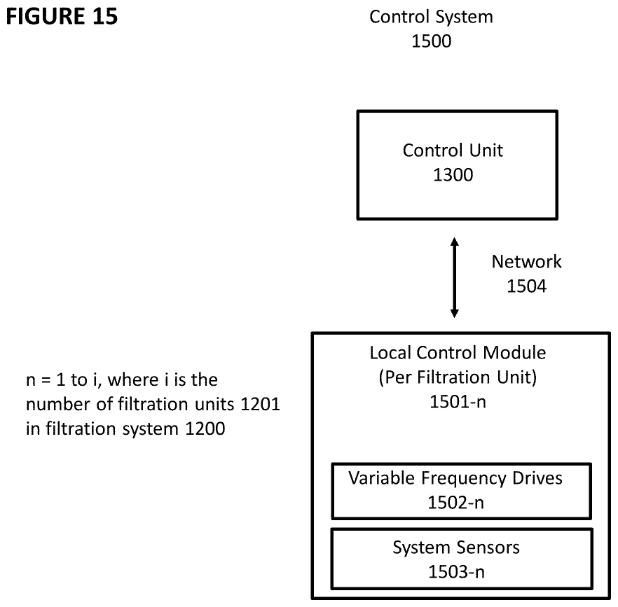

FIG. 2 depicts membrane unit 200. Membrane unit 200 comprises pressure vessel 204, membrane 205, feed valve 206, brine valve 207, product valve 208, and system sensor 1503 (discussed in greater detail below with reference to FIG. 15). Membrane unit 200 receives impure water feed 201 and outputs clean water product 202 and brine 203.

Pressure vessel 204 is a housing made of metal, plastic, or other suitable material that is able to store water at a high pressure. Membrane 205 is a reverse osmosis membrane or set of membranes that allows water to flow through while trapping impurities. Feed valve 206, brine valve 207, and product valve 208 each are an automated valve controlled by an analog or digital control signal received from variable frequency drives 1502 (discussed below with reference to FIG. 15). When closed, each of feed valve 206, brine valve 207, and product valve 208 completely block water from passing through even if the water is at a high pressure.

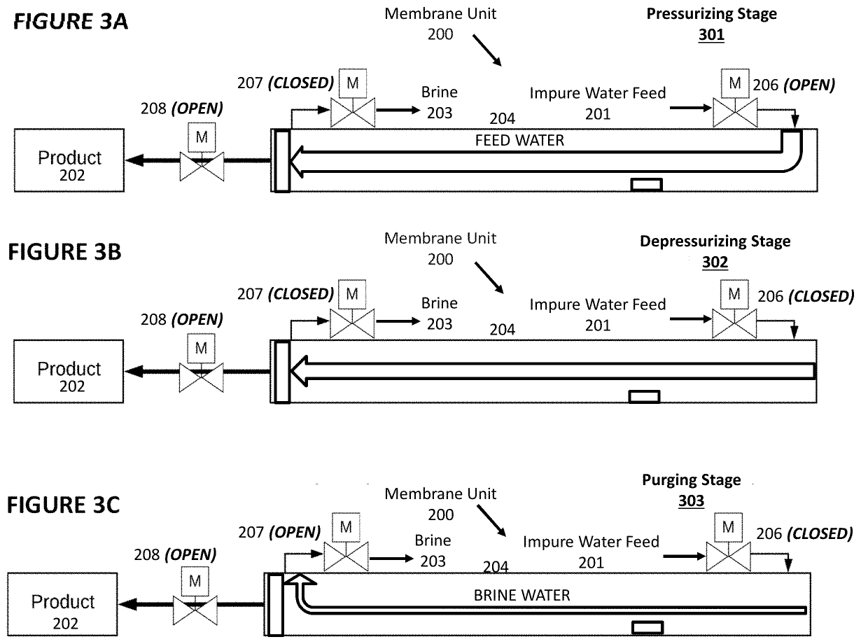

FIGS. 3A, 3B, and 3C depict the operation of membrane unit 200 in three stages: pressurizing stage 301, depressurizing stage 302, and purging stage 303.

FIG. 3A depicts pressurizing stage 301. Feed valve 206 is open, brine valve 207 is closed, and product valve 208 is open. Water is pumped from impure water feed 201 into pressure vessel 204 using any of the pumping mechanisms described below. The water pressure within pressure vessel 204 quickly begins to climb due to water being pumped into pressure vessel 204 at a faster rate than water traverses through membrane 205 through the reverse osmosis process.

FIG. 3B depicts depressurizing stage 302. At the end of pressurizing stage 301, the water pressure within pressure vessel 204 has reached the peak desired pressure. The pumping action then stops and feed valve 206 is closed. Brine valve 207 remains closed, and product valve 208 remains open. Due to the high pressure within pressure vessel 204, water continues to traverse through membrane 205 through reverse osmosis. The relatively high pressure within pressure vessel 204 expedites the reverse osmosis process.

Optionally, pressurizing stage 301 and depressurizing stage 302 can be repeated until the throughput of clean water through product valve 208 falls below a first threshold or the particulate concentration within the water in pressure vessel 204 exceeds a second threshold.

FIG. 3C depicts purging stage 303. Brine valve 207 is opened. Feed valve 206 remains closed, and product valve 208 remains open. In this manner, brine 203 is removed from pressure vessel 204 through brine valve 207, which effectively cleans out pressure vessel 204 and allows the cycle of FIGS. 3A, 3B, and 3C to be repeated.

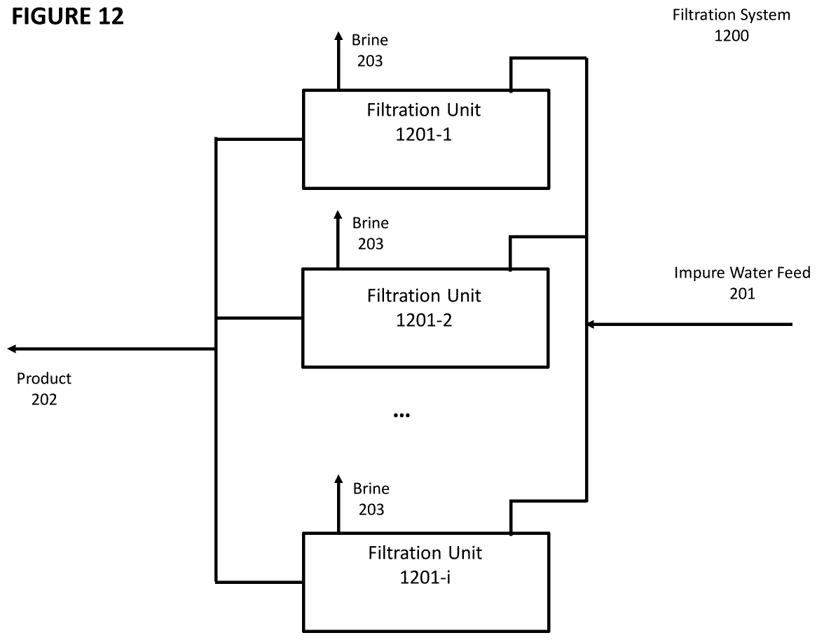

The sequencing of pressurizing stage 301, depressurizing stage 302, and purging stage 303 is controlled by control unit 1200, described in greater detail below with reference to FIG. 12. Control unit 1200 is able to control the volume or throughput of impure water feed 201, clean water product 202, and brine 203, which prior art filtration system 100 is unable to do.

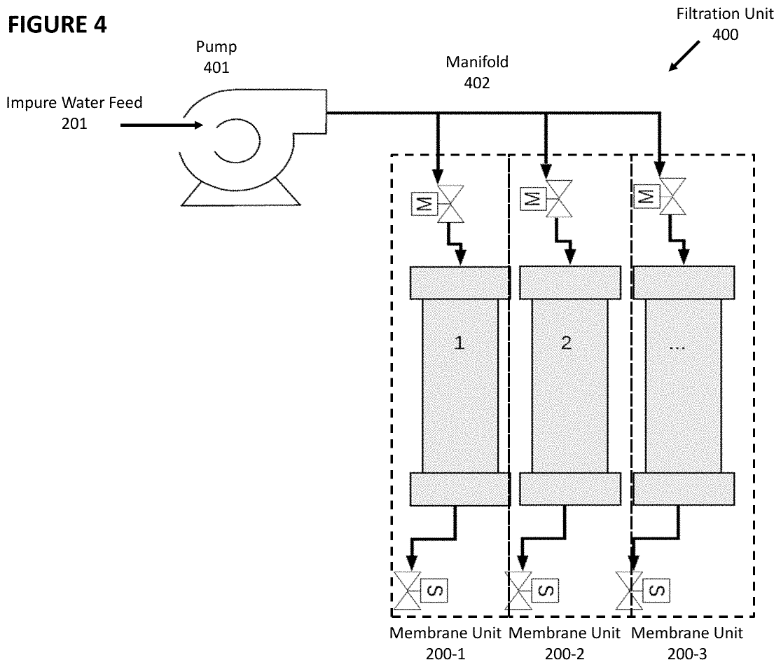

FIG. 4 depicts filtration unit 400. Filtration unit 400 utilizes multiple membrane units 200 in parallel. In this example, three membrane units 200 are used—membrane units 200-1, 200-2, and 200-3. Filtration unit 400 further comprises pump 401, which pumps impure water feed 201, and manifold 402, which distributes impure water feed 201 to membrane units 200-1, 200-2, and 200-3. Filtration unit 400 is suitable for providing clean water for a small building or farm.

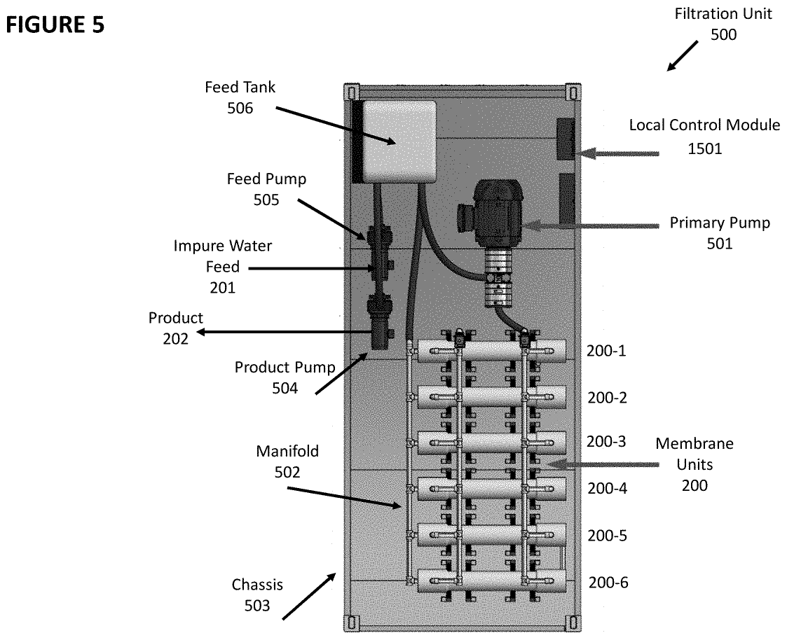

FIG. 5 depicts filtration unit 500. Filtration unit 500 is able to provide a higher throughout of clean water than filtration unit 400 of FIG. 4. Filtration unit 400 is suitable for providing clean water for a large building or farm or for processing water from a fracking process.

Filtration unit 500 utilizes multiple membrane units 200 in parallel. In this example, six units are used—membrane units 200-1, 200-2, 200-3, 200-4, 200-5, and 200-6. Based on applicant's research and development efforts, applicant has determined that up to 20-30 membrane units 200 can be used in parallel for each primary pump 501. Thus, one of ordinary skill in the art will appreciate that FIG. 5 depicts an exemplary configuration and that different numbers of membrane units 200 and other components can be used. Filtration system 500 further comprises primary pump 501, manifold 502, chassis 503, product pump 504, feed pump 505, feed tank 506, and control system 507.

Feed pump 505 receives impure water feed 201 and pumps it towards and into feed tank 506, which is a reservoir, and which feeds into primary pump 501. Primary pump 501 pumps water into manifold 502, which distributes impure water feed 201 to membrane units 200-1, 200-2, 200-3, 200-4, 200-5, and 200-6. Product pump 504 receives product 202 from each of the membrane units and outputs product 202. Chassis 503 is a housing unit for filtration system 500 and optionally comprises, for example, a large metal or plastic container.

Local control module 1501 is described in greater detail below with reference to FIG. 15 and provides analog or digital control signals to primary pump 501, feed pump 505, product pump 504, and the feed valves 206, brine valves 207, and product valves 208 in each of the membrane units 200.

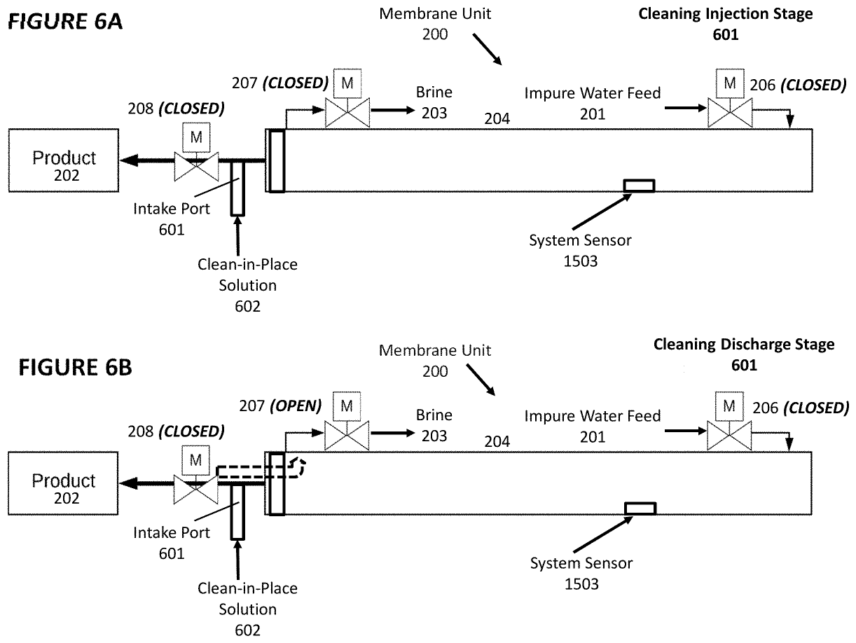

FIGS. 6A and 6B depict another aspect of the embodiments, where a particular membrane unit 200 engages in a clean-in-place process. That is, each membrane unit 200 and its membrane 205 can be cleaned without disassembling membrane unit 200. Some of the membranes can be cleaned while the remainder of the membranes and their associated membrane units are still used to produce clean water.

FIG. 6A depicts cleaning injection stage 601. Feed valve 206 is closed, brine valve 207 is closed, and product valve 208 is closed. Intake port 601 is opened, and clean-in-place solution 602 is injected into intake port 601. Clean-in-place solution 602 can be acidic or basic to remove impurities from membrane 205 and the walls of pressure vessel 204. Optionally, a pump can be used to inject clean-in-place solution 602 with significant pressure. Clean-in-place solution 602 is allowed to circulate within membrane unit 200 for a set period of time.

FIG. 6B depicts cleaning discharge stage 601, which commences after the set period of time has elapsed. Brine valve 207 is opened, and the clean-in-place solution 602 and particulates that have dissolved or been removed from membrane 205 or elsewhere in pressure vessel 204 are discharged through brine valve 207. Thus, in this manner, membrane unit 200 is cleaned in placed with relative ease. This procedure extends the life of membrane 205 and optimizes flow rate and energy consumption. One or more membrane units 200 can be cleaned using this procedure while other membrane units 200 are still engaged in pressurizing stage 301, depressurizing stage 302, or purging stage 303 and providing clean water.

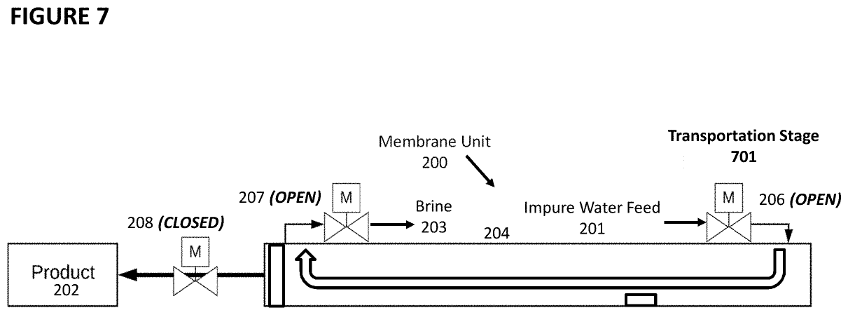

FIG. 7 depicts transportation stage 701. Feed valve 206 is open, brine valve 207 is open, and product valve is closed. Water transportation stage 701 is useful to transfer water quickly from one end of pressure vessel 204 to the other end without filtering the water through membrane 205. This can be used to transport water laterally, for instance, if the filtration activity is going to occur away from the water source. This also allows membrane unit to be bypassed if it is not working for some reason or is not needed.

The different possible stages of membrane unit 200 and the associated states of feed valve 206, brine valve 207, and product valve 208 are summarized in Table 1:

TABLE 1
STAGES OF MEMBRANE UNIT 200

| | State of | State of | State of |
|---|---|---|---|
| | Feed | Brine | Product |
| Stage of Membrane Unit 200 | Valve 206 | Valve 207 | Valve 208 |
| Pressurizing Stage 301 | Open | Closed | Open |
| Depressurizing Stage 302 | Closed | Closed | Open |
| Purging Stage 303 | Closed | Open | Open |
| Cleaning Injection Stage 601 | Closed | Closed | Closed |
| Cleaning Discharge Stage 602 | Closed | Open | Closed |
| Transportation Stage 701 | Open | Open | Closed |
| Offline 801 | Closed | Closed | Closed |

Offline stage 801 can be used when membrane unit 200 is not in use (i.e., it is offline). In offline stage 801, feed valve 206, brine valve 207, and product valve 208 each are closed.

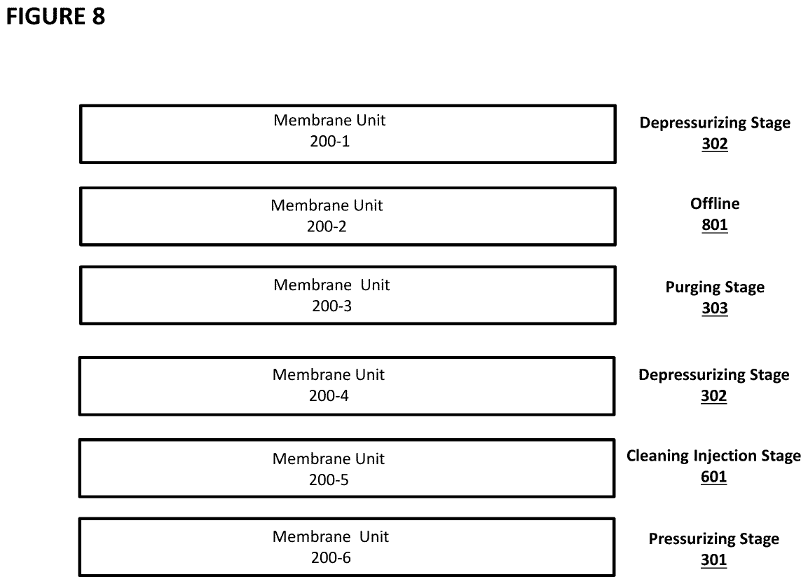

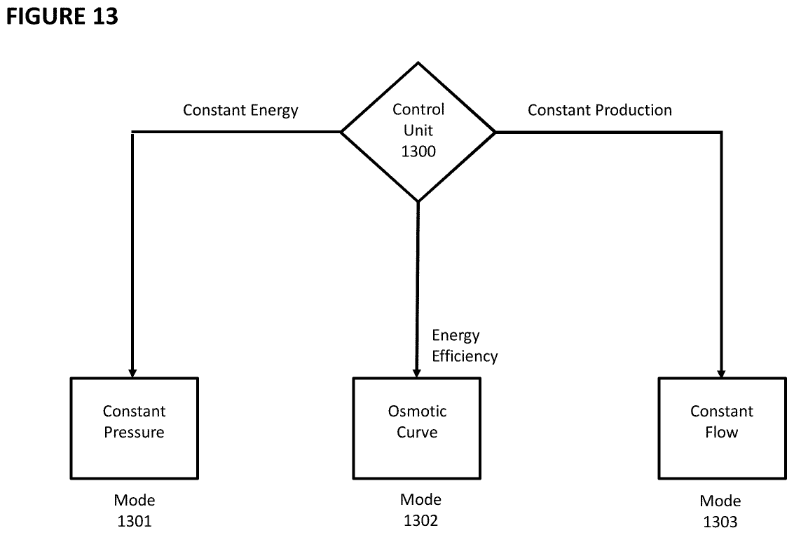

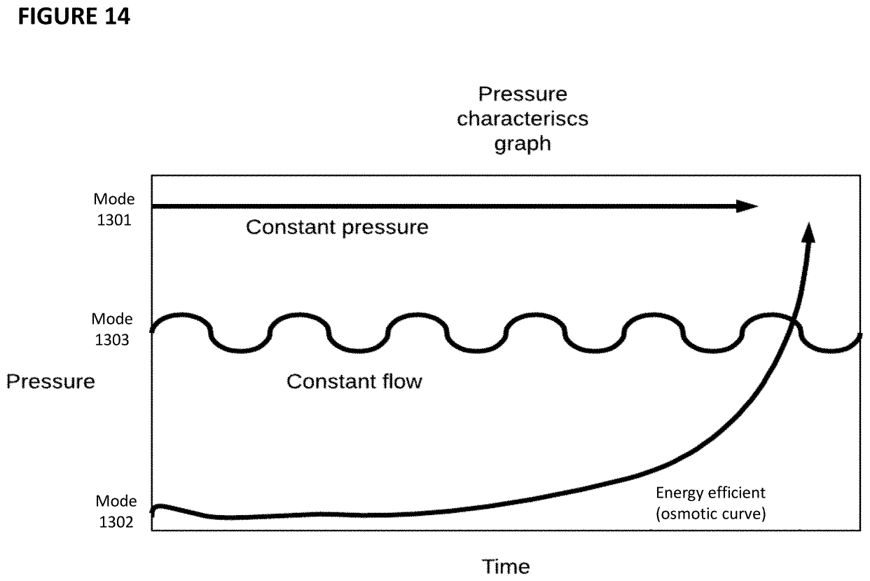

FIG. 8 depicts the flexibility of filtration units built according to the embodiments of the invention. A filtration unit, such as filtration unit 500, comprises six membrane units 200. At the particular point in time shown in this example, membrane unit 200-1 is in depressurizing stage 302, membrane unit 200-2 is in offline stage 801, membrane unit 200-3 is in purging stage 303, membrane unit 200-4 is in depressurizing stage 302, membrane unit 200-5 is in cleaning injection stage 601, and membrane unit 200-6 is in pressurizing stage 301. As will be discussed in greater detail below with reference to FIGS. 13 and 14, this flexibility allows the system to be optimized for different factors, such as energy consumption and clean water throughput.

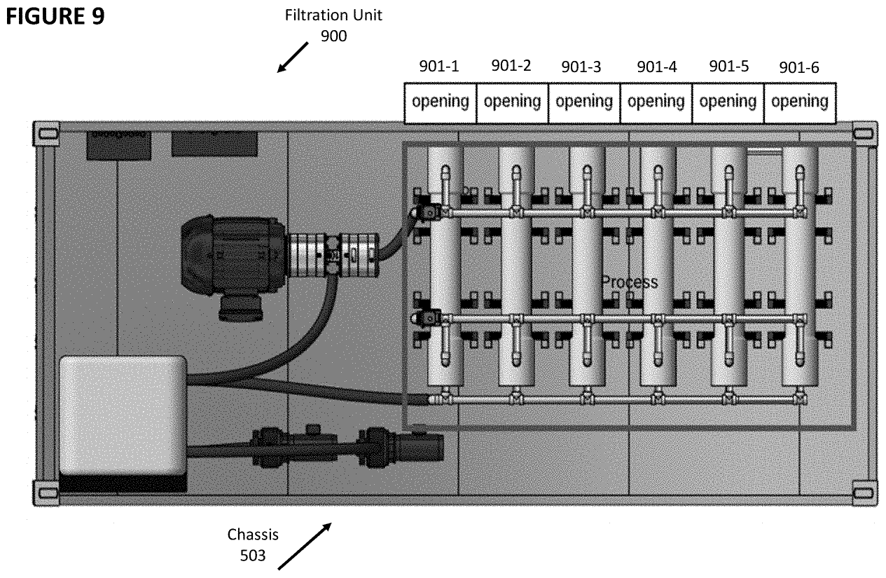

FIG. 9 depicts filtration unit 900, which is identical to filtration unit 500 in FIG. 5 except that chassis 503 contains openings 901-1, 901-2, 901-3, 901-4, 901-5, and 901-6 above membrane units 202. This allows for easy access to each membrane 205 in each membrane unit 202 when it is necessary to replace membrane 205. In the prior art, replacing membranes was a very difficult process and typically required full system shutdown for approximately 20 minutes to replace a single membrane, which is a significant drawback if the system contains many membranes.

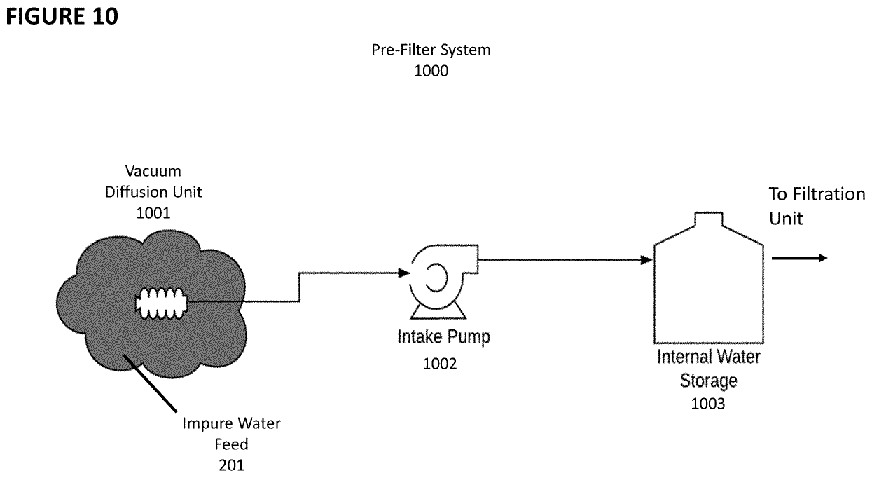

FIG. 10 depicts optional pre-filter system 1000, which can provide initial filtering to impure water feed 201 if impure water feed 201 is particularly polluted. Vacuum diffusion unit 1001 is placed in impure water feed 201. Vacuum diffusion unit 1001 optionally can be the pretreatment stage product known by the trademark “PROTEKTOR.” The output of vacuum diffusion unit 1001 is provided to intake pump 1002, which pumps the water to internal water storage 1003, which serves as a reservoir that then supplies the filtration unit such as filtration units 400, 500, 900, or 1100. In an alternative embodiment, a micro-filtration pre-treatment step can be used instead of pre-filter system 1000. In another alternative embodiment, neither a micro-filtration pre-treatment step nor pre-filter system 1000 are used.

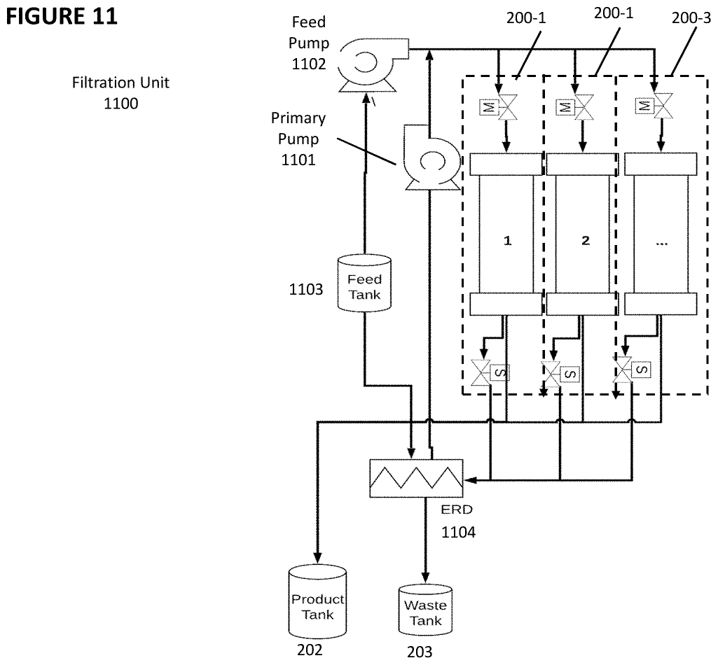

FIG. 11 depicts filtration unit 1100. Filtration unit 1100 comprises primary pump 1101, feed pump 1102, feed tank 1103, energy recovery device 1104, membrane units 200-1, 200-2, and 200-3, product tank 202 and brine tank 203. The stages of multiple membrane units 200-1, 200-2, and 200-3 are sequenced by control unit 1300 (not shown here but shown in FIG. 13) to allow for a continuous flow of brine instead of an intermittent flow. This allows energy to be recaptured by energy recovery device 1104. Here, energy recovery device 1104 can be a pressure exchange. One of ordinary skill in the art will appreciate that FIG. 11 depicts an exemplary configuration and that different numbers of membrane units 200 and other components can be used.

FIG. 12 depicts filtration system 1200. Filtration system 1200 illustrates the scalability of the embodiments. Filtration system 1200 comprises i filtration units—filtration units 1201-1, 1201-2, . . . , 1201-i—each of which is one of filtration units 400, 500, 900, or 1100 described above. Filtration units 1201-1, 1201-2, . . . , 1201-i are connected in parallel to impure water feed 201. Brine 203 can be collected separately from each filtration unit or combined, and optionally can be fed into a pressure exchanger such as energy recovery device 1104 in FIG. 11. Product 202 also can be collected separately from each filtration unit or combined. Filtration system 1200 is suitable for providing clean water for an entire town or city.

FIGS. 13 and 14 depicts three modes in which filtration system 1200 or filtration units 400, 500, 900, or 1100 can operate. The modes are implemented by control unit 1300. Control unit 1300 implements one of the three modes through its control of the sequencing of staging of each membrane unit 200 in the filtration unit or filtration system.

In mode 1301, control unit 1300 attempts to maintain constant energy consumption by the filtration unit or filtration system by attempting to keep the average pressure of all membrane units 200 at a constant value.

In mode 1302, control unit 1300 attempts to minimize energy consumption by the filtration unit or filtration system by producing clean water according to an osmotic curve to optimize energy efficiency, recognizing that as particulate concentration increases over time, the pressure required to maintain the reverse osmotic reaction increases.

In mode 1303, control unit 1300 attempts to maintain a constant flow of clean water. It maintains a near-constant flow rate by oscillating around a constant average pressure among all membrane units 200.

FIG. 15 depicts control system 1500 used for filtration system 1200, or in smaller configurations, filtration units 400, 500, 900, or 1100. Control system 1500 comprises control unit 1300 and local control modules 1501-1, . . . , 1501-i, where i is the number of filtration units 1201 in filtration system 1200 or that are otherwise part of the system being controlled. Each filtration unit 1201-n contains local control module 1501-n.

Control unit 1300 can comprise a Programmable Logic Controller (PLC), a microprocessor, or other programmable logic. An administrator or user can configure control unit 1300 to implement modes 1301, 1302, or 1303, or some other mode. Control unit 1300 communicates with local control modules 1501-1, . . . , 1501-i through network 1504. Network 1504 can comprise a wireless connection (such as a cellular network connection, a WiFi connection, or a connection known by the trademark “BLUETOOTH”) or a wired connection (such as Ethernet or a fibre optic cable).

Each local control module 1501-n (where n ranges from 1 to n) comprises variable frequency drive 1502-n, which provides analog or digital control signals to the pumps 401, 501, 504, 505, 1101, 1102; feed valves 206; brine valves 207; and product valves 208 in filtration unit 1201-n to open and close the valves and to control the pumps as needed. Each local control module 1501-n further comprises system sensors 1503-n, which can measure various characteristics within filtration unit 1201-n, such as pressure, flow, time, temperature, water level, vibration, and conductivity. System sensors 1503-n send measured information to local control module 1501-n, which sends it to control unit 1200 over network 1504.

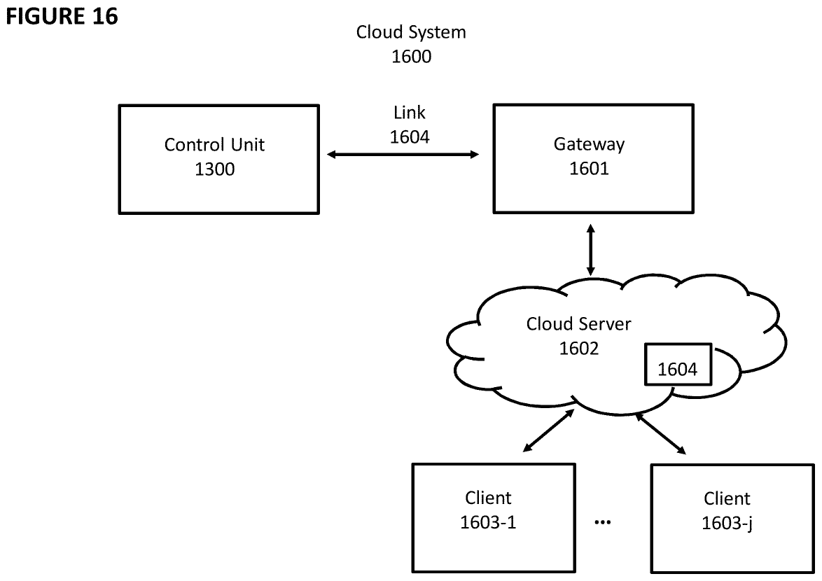

FIG. 16 depicts cloud system 1600. Optionally, control unit 1300 is connected to gateway 1601 over link 1604. Gateway 1601 is connected to cloud server 1602 over the Internet or other network, and cloud server 1602 is connected to clients 1603-1, . . . , 1603-j over the Internet or other network, where j is the number of clients with access privileges to cloud server 1602. Cloud server 1602 and clients 1603 are computing devices containing processing units capable of executing software instructions stored in memory.

An administrator or user can access cloud server 1602 from a client 1603 to configure and control unit 1200, for instance, by selecting modes 1301, 1302, or 1303 as the mode of operation for filtration system 1200.

Cloud server 1602 optionally can host a web page accessible by clients 1603 to enable clients 1603 to configure control unit 1300.

Cloud server 1602 optionally comprises data analytics module 1604. Data analytics module 1604 gathers data from control unit 1300 and other control units associated with other filtration systems 1200 and predicts:
Most efficient energy curve, where it determines the configuration to achieve the lowest energy consumption per gallon produced;
Maximum pressure for the system, where it determines the highest attainable pressure given the level of water contamination;
Maximum flow rate achievable given the level of water contamination;
Minimum purge time;
Optimized purge sequencing, where it determines the number of membranes, time to purge, volume of the fluid purged to achieve the best outcome as to one more of the following factors: (1) Water contamination (TDS) range; (2) Electrical cost rate; (3) Time schedule for reduced production, i.e., when the feed TDS and/or operating costs are high; (4) Time schedule for increased production, i.e., when the feed TDS and/or operating costs are low; (5) Membrane life expectancy: The system can determine membranes that need servicing given a drop in the flow rate; and (6) Clean-in-Place Operations: Membrane cleaning cycles based on the level of water contamination.

The embodiments described herein are able to overcome the drawbacks of filtration system 100 are able to clean and, when applicable, desalinate pond water, lake water, saltwater, industrial wastewater, and other impure water with greater clean water throughout for a given amount of energy consumption. Applicant has built and tested the embodiments described herein and has achieved recovery rates of 90% for an impure water feed of <15,000 TDS, 85% for an impure water feed of 15,000-45,000 TDS, and 80% for an impure water feed of 45,000+TDS, while consuming power at a rate of 1.6 kWh/m³. This is a substantial improvement over the prior art.

It should be noted that, as used herein, the terms “over” and “on” both inclusively include “directly on” (no intermediate materials, elements or space disposed therebetween) and “indirectly on” (intermediate materials, elements or space disposed therebetween).

What is claimed is:

1. A filtration unit for receiving an impure water feed and generating a brine feed and a clean water feed, the filtration unit comprising:
a pump for pumping the impure water feed;
a plurality of membrane units configured to receive the impure water feed and to generate the brine feed and the clean water feed, each of the membrane units comprising:
a pressure vessel;
a reverse-osmosis membrane;
an electrically-controlled feed valve for controlling the input of a some or all of the impure water feed into the pressure vessel;
an electrically-controlled brine valve for controlling the output of brine from the pressure vessel into the brine feed; and
an electrically-controlled product valve for controlling the output of clean water from the pressure vessel into the clean water feed; and
a control unit for controlling the pump, and the feed valve, the brine valve, and the product valve in each membrane unit in the plurality of membrane units to regulate pressure in each membrane unit to generate the clean water feed.

2. The filtration unit of claim 1, further comprising a chassis enclosing the pump, the plurality of membrane units, and the control unit.

3. The filtration unit of claim 2, wherein the chassis contains an opening for each of the plurality of membrane units to allow access to each of the membrane units.

4. The filtration unit of claim 1, further comprising a manifold between the pump and the plurality of membrane units.

5. The filtration unit of claim 1, further comprising a product pump for pumping the clean water feed.

6. The filtration unit of claim 1, wherein each of the membrane units further comprises an intake port for receiving clean-in-place solution to clean the reverse-osmosis membrane.

7. The filtration unit of claim 1, wherein the clean water feed is provided to an energy recovery device.

8. The filtration unit of claim 7, wherein the energy recovery device is a pressure exchange.

9. The filtration unit of claim 1, wherein each of the membrane units further comprises a sensor for measuring water pressure within the membrane unit.

10. The filtration unit of claim 1, wherein the pressure vessel comprises plastic.

11. The filtration unit of claim 1, wherein the pressure vessel comprises metal.

12. A method of filtering an impure water feed to generate a clean water feed and a brine feed, the method comprising:
opening, in response to a signal from a control module, a feed valve in a membrane unit;
closing, in response to a signal from the control module, a brine valve in the membrane unit;
opening, in response to a signal from the control module, a product valve in the membrane unit;
pumping water from the impure water feed through the feed valve into the membrane unit;
closing, in response to a signal from the control module, the feed valve;
filtering water through a reverse-osmosis membrane in the membrane unit to generate clean water; and
receiving clean water through the product valve and providing clean water to the clean water feed.

13. The method of claim 12, further comprising:
opening, in response to a signal from the control module, the brine valve; and
receiving brine through the brine valve and providing the brine to the brine feed.

14. The method of claim 12, further comprising:
closing, in response to a signal from the control module, the product valve;
opening an intake port in the membrane unit; and
injecting clean-in-place solution into the intake port to clean the membrane.

15. The method of claim 14, further comprising:
opening, in response to a signal from the control module, the brine valve; and
receiving the clean-in-place solution through the brine valve.

16. A method of filtering an impure water feed by a filtration system to generate a clean water feed and a brine feed, the filtration system comprising a plurality of filtration units, each filtration unit comprising a plurality of membrane units, each membrane unit comprising a pressure vessel, a feed valve, a product valve, and a brine valve, the method comprising:
sequencing, by a control system, each of the membrane units in the filtration system through a pressurizing stage, a depressurizing stage, and a purging stage by controlling the feed valve, product valve, and brine valve for each membrane unit to generate the clean water feed and the brine feed from the impure water feed.

17. The method of claim 16, wherein the sequencing achieves an approximately constant average water pressure across the membrane units in the filtration system.

18. The method of claim 16, wherein the sequencing achieves an approximately constant clean water feed.

19. The method of claim 16, wherein the sequencing produces the clean water feed according to an osmotic curve.

20. The method of claim 16, further comprising:
configuring, by a cloud server over a network, the control system to perform the sequencing step.

21. The method of claim 20, wherein the configuring is performed in response to commands received by the cloud server from a client over the network.
